(19) United States
(12) Patent Application Publication
(10) Pub. No.: US 2005/0258649 A1
(43) Pub. Date: Nov. 24, 2005

(54) Pipe sleeve connection in a water heater steel storage tank

(76) Inventor: Chris R. Braathen, Oslo (NO)

Correspondence Address: FROMMER LAWRENCE & HAUG, 745 FIFTH AVENUE- 10TH FL., NEW YORK, NY, 10151, US

(21) Appl. No.: 11/113,566

(22) Filed: Apr. 25, 2005

(30) Foreign Application Priority Data
May 5, 2004 (NO) 2004 1923

(51) Int. Cl. F16L 15/00

(52) U.S. Cl. 285/390

(57) ABSTRACT

Method for establishing a secure pipe sleeve connection in a water heater steel tank, comprising pressing a straight portion (7) of the material of the tank wall into the interior of the tank or outwardly to the exterior of the tank (1), to model internal threads (2) in the straight portion (7) by thread rolling threads (2), and to screw into the straight portion (7) a pipe sleeve (3) having corresponding external threads.

Pipe sleeve connection in a water heater steel tank, comprising a pipe sleeve (3) having outer threads is screwed into a straight portion (7) being pressed inwardly or outwardly from the material of the tank wall and being provided with rolled internal threads (2).

The present invention is related to a pipe sleeve connection to a water heater steel storage tank.

Such storage tanks normally are manufactured of stainless steel with two cupola like parts, one at the top and one at the bottom, together with a cylindrical part having a circular cross section there between, possibly only with two cupola like parts. The parts of the tank are welded to each other.

Connecting pipes for water inlet and water outlet are connected to and penetrate the steel tank. In this connection normally sockets or sleeves are used which are welded to the tank and being provided with internal or external threads for connection of pipes or valves. Additionally the tank comprises other connections such as safety valve, at least one immersion heater, internal heat exchanger etc.

Welding as such is an expensive process which also makes large demands on the is performance of the welding processes and the welding metallurgy. The extreme heating during the welding process creates oxide scale and additional, oxidation which lower the resistance against corrosion and which also is negative in relation to the lifetime of the water heater.

For the rest the welding process has to be performed from the inside of the tank to avoid crevice corrosion. All together welding also constitutes a labour intensive process which to a large extent includes possibilities for faults by deviations from the defined parameters during the welding process. This again makes the process expensive.

Manufacturing of threads in the tank material by means of cutting tools is precluded due to the small thickness of the material in the steel tank. The solution therefor was to secure a pipe sleeve having interior threads to the tank material by welding.

With the method and the pipe sleeve connection according to the present invention the above disadvantages by prior art are avoided. This is achieved with the method and the pipe sleeve connection according to the invention as defined by the features stated in the claims.

The drawing discloses in

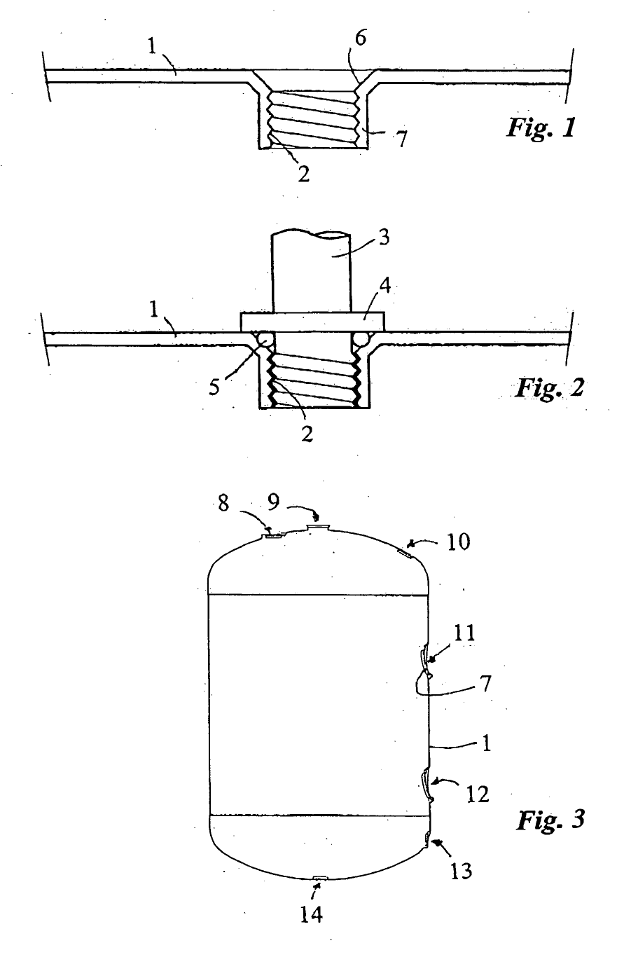

FIG. 1 schematically a prepared thread connection in the steel tank in a section,

FIG. 2 discloses the connection in FIG. 1 upon connection of a pipe fitting, and

FIG. 3 discloses schematically a vertical section through a water heater storage tank.

FIG. 1 discloses a segment of a water heater steel tank from which a straight pipe portion 7 has been pressed into the inside of a tank 1 or outwardly to the exterior of the tank 1, depending on the need for the connecting part.

Simultaneously with the pressing and shaping of the straight portion 7 from the tank 1 material it is preferred to form a contact face 6 between the straight portion 7 and the tank wall or the top or bottom cupola. The contact face 6 may be conical or have other suitable shape to receive an O-ring and possibly other sealing means. Interior threads 2 thereafter are modelled in the pipe sleeve 2 by thread rolling, which means that the basic material of the straight portion 7 is transformed to be internal threads. This operation may be accomplished without removing any material from the tank 1.

A pipe sleeve 3 is modelled in a corresponding way to be provided with outer threads and comprises a plan flange 4. An O-ring is fit on to the threaded portion of the pipe 3 against the flange 4, whereafter the pipe 3 is screwed on to the straight portion 7 to be secured in the threads in such a way that the O-ring is pretensioned between the flange 4, the pipe 3 and the face 6 with a pressure to withstand at least the testing pressure for the water heater tank, substantially higher as the operation pressure for which the water heater is manufactured. Rolling threads may be produced with high precision for pipe sleeves between ½″ and 2″ pipe threads.

To secure sealing of the connection liquid thread dope or thread locking may be use in addition to the O-ring.

FIG. 3 discloses connections 8, 10, 11, 12, 13 and 14 with the straight portion 7 extending inwardly into the tank 1, whereas the straight portion 7 of the connection 9 extends outwardly. Connections 11 and 12 are directed in an inclined angle such as for a heater element, which connection comprises a portion of the tank wall being pressed to be flat and at an acute angle to the horizontal plane. Upon provision of a flat inclined surface a straight portion 7 is shaped as described above.

1. Method for establishing a secure pipe sleeve connection in a water heater steel tank, wherein pressing a straight portion (7) of the material of the tank wall into the interior of the tank or outwardly to the exterior of the tank (1), to model internal threads (2) in the straight portion (7) by thread rolling threads (2), and to screw into the straight portion (7) a pipe sleeve (3) having corresponding external threads.

2. Method according to claim 1, wherein forming a conical internal contact face (6) at the transition of the straight portion (7) to the material of the tank.

3. Method according to claim 1, wherein fitting an O-ring in such a way on the pipe sleeve (3) that the O-ring is pretensioned between a flange (4) on the pipe sleeve (3), a contact face (6) between the straight portion (7) and the tank (1) wall with a pressure a twice the normal operation pressure for the water heater.

4. Pipe sleeve connection in a water heater steel tank, wherein a pipe sleeve (3) having outer threads is screwed into a straight portion (7) being pressed inwardly or outwardly from the material of the tank wall and being provided with rolled internal threads (2).

5. Pipe sleeve connection according to claim 4, wherein forming an internal contact face (6) at the transition between the straight portion (7) and the material of the tank wall.

6. Pipe sleeve connection according to claim 5, wherein the internal contact face (6) being a conical surface.

7. Pipe sleeve connection according to claim 5, wherein an O-ring being pretensioned between the contact face (6), the pipe sleeve (3) and a flange (4) arranged on the pipe sleeve (3).

8. Pipe sleeve connection according to claim 6, wherein an O-ring being pretensioned between the contact face (6), the pipe sleeve (3) and a flange (4) arranged on the pipe sleeve (3).
